(19) United States
(12) Patent Application Publication
(10) Pub. No.: US 2017/0035217 A1
(43) Pub. Date: Feb. 9, 2017

(54) CHILD SEAT

(71) Applicants: JAMES JOHN THORN, ROCHFORD (GB); OAKTHRIFT CORPORATION LTD, HERTFORDSHIRE (GB)

(72) Inventor: JAMES JOHN THORN, ROCHFORD (GB)

(21) Appl. No.: 15/304,766

(22) PCT Filed: Oct. 15, 2015
(86) PCT No.: PCT/GB2015/051124

§ 371 Date: Oct. 17, 2016

(30) Foreign Application Priority Data
Apr. 15, 2014 (GB) 1406749.0

(51) Int. Cl. A47D 1/10; A47D 15/00; B60N 2/28; B64D 11/06

(52) U.S. Cl. CPC A47D 1/103; B64D 11/0612; B64D 11/062; A47D 15/006; B60N 2/2806; B60N 2002/2896

(57) ABSTRACT

An inflatable child seat comprises an inflatable base, inflatable front and rear supports, and first and second inflatable side supports. The base connects together the front, rear and side supports, and the side supports connect together the front and rear supports. The front support has at least one opening through which a child's legs may extend when the seat is in use.

Child seats are required in many situations, both in a domestic setting and whilst travelling.

Many different type of child seats have been developed, including many for static chairs, car seats, and some adapted for aeroplane travel.

However, not all seats are as protective of a child as parents might desire, as owing to underdeveloped motor skills children have a tendency to collapse in different directions, predominantly forwards.

Such movements can be heightened during travel, especially on aeroplane flights that experience severe turbulence, where children may be thrown violently in different directions, and particularly forward as a child body naturally folds in that direction.

The present invention seeks to address these issues.

According to the present invention there is provided an inflatable child seat comprising:
an inflatable base;
inflatable front and rear supports;
first and second inflatable side supports;
wherein
the base connects together the front, rear and side supports;
the side supports connect together the front and rear supports;
the front support has at least one opening through which a child's legs may extend when the seat is in use.

By providing a child seat wherein the base, front, rear and side supports are all inflatable the child seat may be made extremely compact for transit.

Furthermore, an inflatable front support means that a child is less likely to be injured by falling forwards against the support, either when the seat is stationary, but particularly when in transit, for example on an aeroplane experiencing turbulence. The front support essentially acts as an airbag for the child. The provision of inflatable rear and side supports further cushions a child in the child seat, provides for an extremely robust structure that surrounds a child on all sides, and allows for the child seat to be deflated for ease of transportation.

In some embodiments the seat comprises a harness suitable to retain a child in the seat.

In some embodiments the seat comprises at least one connection member suitable to attach the seat to a chair.

By providing at least one connection member (particularly in the form of a strap or belt) to attach the child seat to a chair the child seat may be used with standard chairs while travelling, for example in cafes, restaurants and waiting areas

In some embodiments the child seat comprises a first connection member suitable to connect the child seat to a seat of a chair and a second connection member suitable to connect the child seat to a back of a chair.

In some embodiments the first connection member is formed in two parts with a first part extending from a first side of the base and a second part extending from a second side of the base.

In some embodiments the second connection member is formed in two parts with a first part extending from a first side support and a second part extending from a second side support.

By providing first and second connection members (particularly in the form of straps or belts) the child seat may be most securely attached to a chair.

Preferably the front support comprises first and second openings through which respective legs of a child may extend when the seat is in use.

By providing two leg holes a child may be securely retained within the child seat and cannot slide out of the child seat through a hole at the front of the seat.

In some embodiments the child seat comprises a pair of openings through which an aeroplane seatbelt may be positioned over a child's lap such that the seatbelt restrains a child sat on the child seat.

In some embodiments each side support comprises an opening through which an aeroplane seatbelt may be positioned over a child's lap such that the seatbelt restrains a child sat on the child seat.

By providing a pair of openings for the child seat to attach to an aeroplane seat belt the seat and a child may simultaneously be securely attached to an aeroplane chair using the aeroplane seatbelt.

In some embodiments the child seat comprises at least one non-return valve and at least one standard air valve.

In some embodiments the base is in fluid connection with the side supports.

In some embodiments the base is in fluid connection with the side and rear supports so as to allow simultaneous inflation and deflation thereof.

In some embodiments the base is in fluid connection with the side, front and rear supports so as to allow simultaneous inflation and deflation thereof.

By forming the base is in fluid connection with one or more of the side and rear supports, and in some embodiments the front support, not only may a user simultaneously inflate and deflate the respective chambers, but the weight of a child pressurizes the base, in turn pressurizing the supports that are in fluid communication with the base. This acts to increase the robustness of the child seat.

In order that the present invention may be more fully understood a specific embodiment will now be described by way of example with reference to the accompanying drawings, of which:

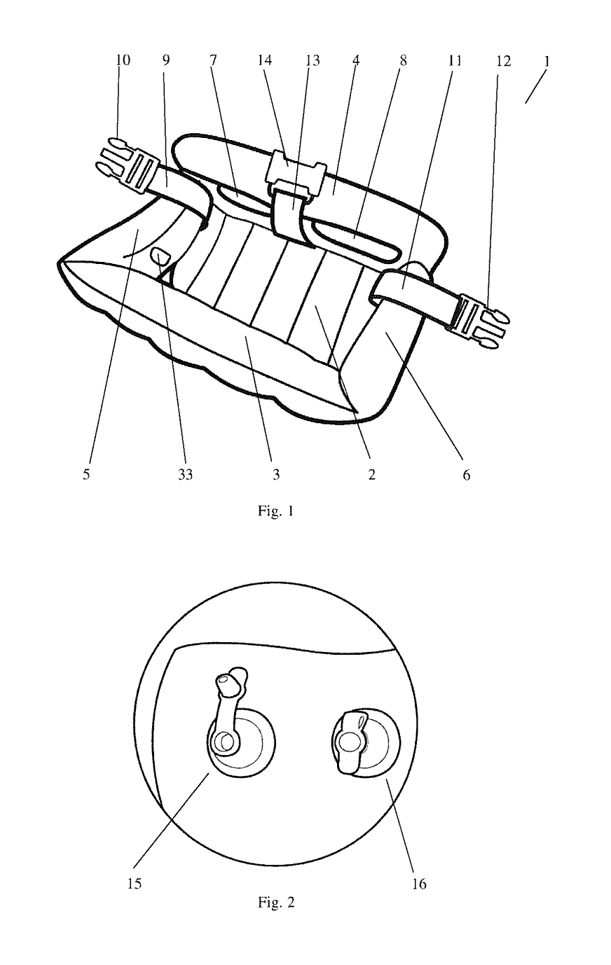

FIG. 1 is a perspective view from above of a child seat made in accordance with the present invention;

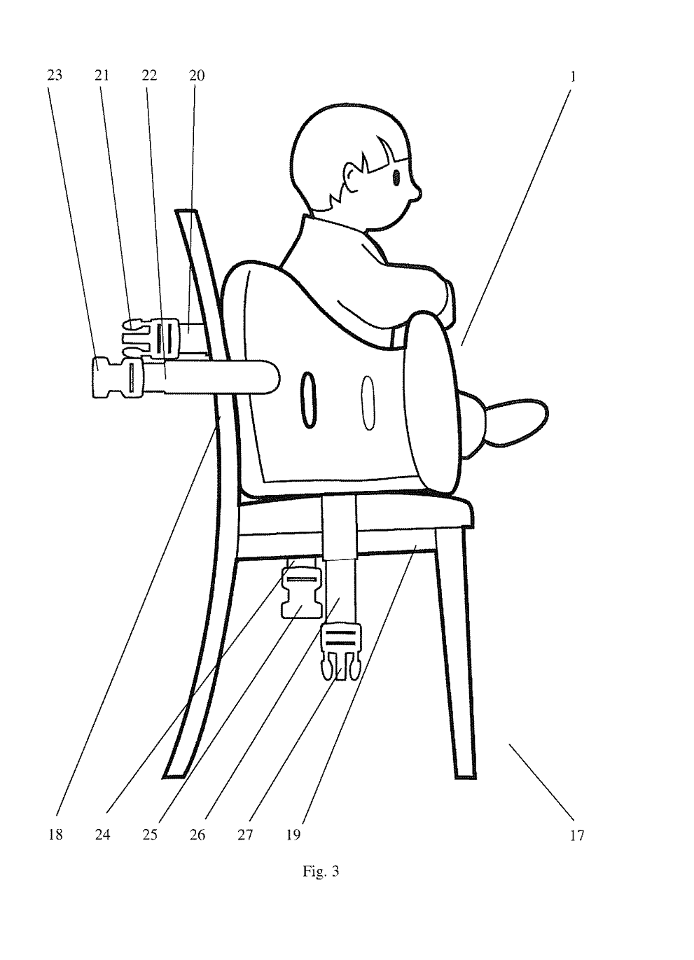

FIG. 2 is a view of the air valves of the child seat of FIG. 1;

FIG. 3 is a side view of the seat of FIG. 1 showing the chair attachment belts thereof;

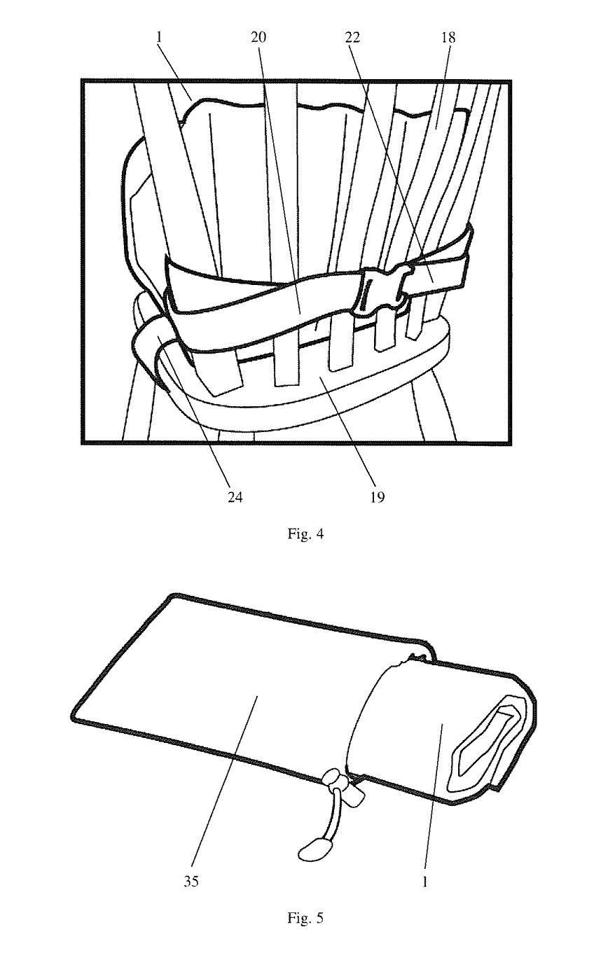

FIG. 4 is a view of the seat of FIG. 1 attached to a chair;

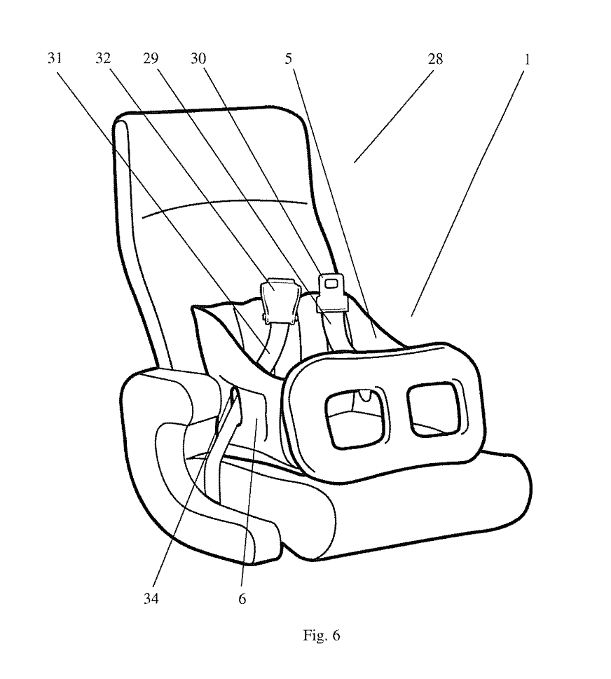

FIG. 5 is a view of the seat of FIG. 1 in a deflated state; and

FIG. 6 is a perspective view of the seat of FIG. 1 showing how it attached to an aeroplane chair by means of an aeroplane seatbelt.

Referring to FIG. 1 there is provided a child seat 1 having a base 2, rear support 3, front support 4 first side support 5 and second side support 6, all of which are inflatable. Thus, substantially the entire child seat is inflatable.

Each of rear support 3, front support 4 first side support 5 and second side support 6 are connected to base 2.

First side support 5 connects together rear support 3 and front support 4 at the first side of child seat 1, and similarly second side support 6 connects together rear support 3 and front support 4 at the second side of child seat 1.

Front support 4 comprises a first leg hole 7 adjacent first side support 5, and also comprises a second leg hole 8 adjacent second side support 6.

First and second leg holes 7, 8 are adapted for a child to extend its legs therethrough when child seat 1 is in use.

Adjacent front support 4 is located a safety belt to harness a child within child seat 1.

The safety belt, or ‘harness’, is formed in three parts—first safely belt portion 9 extending from base 2 adjacent first side support 5 and having first male connector 10 at its free end, second safely belt portion 11 extending from base 2 adjacent second side support 6 and having second male connector 12 at its free end, and third safely belt portion 13 extending from base 2 between first and second leg holes 7, 8 and comprising double female connector 14 at its free end.

First, second and third safety belt portions 9, 11, 13 are all formed of webbing, and first and second safety belt portions 9, 11 are adjustable in length by means of adjustment buckle parts of first and second male connectors 10, 12.

Double female connector is adapted to connect to both first male connector 10 and second male connector 12 simultaneously.

Although in the present embodiment first and second safety belt portions 9, 11 extend from base 2 adjacent respective side portions, first and second safety belt portions may extend from other areas of child seat 1, for example from rear support 3.

On its outward-facing surface rear support 3 comprises two air valves: non-return valve 15 and standard air valve 16.

Non-return valve 15 only allows air in to child seat 1, and thereby allows a user to achieve maximum inflation thereof.

In contrast standard air-valve 16 provides no control over the direction of airflow and thereby allows a user to rapidly deflate child seat 1.

FIGS. 3 and 4 illustrate how child seat 1 may be attached to a chair 17 having a chair back 18 and a chair seat 19.

Adjacent rear support 3 is located rear attachment belt adapted to attach child seat 1 to chair back 18.

Rear attachment belt is formed in two parts—first rear attachment belt portion 20 extending from first side support 5 and having male connector 21 at its free end, and second rear attachment belt portion 22 extending from second side support 6 and having female connector 23 at its free end.

First, second rear belt portions 20, 22 are formed of webbing, and are adjustable in length by means of adjustment buckle parts of male and female connectors 21, 23.

Adjacent base 2 is located lower attachment belt adapted to attach child seat 1 to chair seat 19.

Lower attachment belt is formed in two parts—first lower attachment belt portion 24 extending from base 2 adjacent first side support 5 and having male connector 25 at its free end, and second rear attachment belt portion 26 extending from base 2 adjacent second side support 6 and having female connector 27 at its free end.

First, second lower belt portions 24, 26 are formed of webbing, and are adjustable in length by means of adjustment buckle parts of male and female connectors 25, 27.

Thus lower and rear attachment belts may be adjusted in length so as to tightly attach child seat 1 to any shape and size of chair.

Referring to FIGS. 1 and 6 it can be seen that child seat 1 may be easily attached to an aeroplane seat 28 by means of an aeroplane seat belt.

A two-point aeroplane seat belt typically comprises a first belt portion 29 having a male connector portion 30 and a second belt portion 31 having a female connector portion 32. Such an aeroplane seat belt is adjustable in length owing to an adjustment buckle that forms part of female connector 32.

Child seat 1 comprises in first side support 5 and adjacent rear support 3 first opening 33 adapted to have male connector portion 30 and first belt portion 29 pass therethrough.

Child seat 1 also comprises in second side support 6 and adjacent rear support 3 first opening 34 adapted to have female connector portion 32 and first belt portion 31 pass therethrough.

Male connector portion 30 and female connector portion 32 may then be connected together such that the aeroplane seatbelt is located over base 2.

Thus, the aeroplane seat belt may be positioned over the lap of a child sat on base 2, and the aeroplane seat belt tightened so as to securely retain the child and child seat 1 on aeroplane seat 28.

When secured to an aeroplane seat 28 child seat 1 is front-facing, in that a child is retained facing forward on the seat.

It should be noted that although suitable for use as a booster seat on an aeroplane a child seat made in accordance with the present invention is entirely unsuitable for use as a car booster seat.

As substantially all of child seat 1 (other than the safety and attachment belts) is inflatable, child seat 1 is highly transportable.

As can be seen in FIG. 5, when fully deflated child seat 1 may be rolled up and transported in a storage bag 35

In some embodiments more than one inflatable chamber may form the child seat. Thus, for example the front may be separately inflatable from the base and the side and rear supports. Although undesirable from a user's perspective the provision of separate chambers may be desirable to minimize the risk of splits developing.

Many variations are possible without departing from the scope of the present invention as set out in the appended claims.

1. An inflatable child seat comprising:
an inflatable base;
inflatable front and rear supports;
first and second inflatable side supports;
wherein
the base connects together the front, rear and side supports;
the side supports connect together the front and rear supports;
the front support has at least one opening through which a child's legs may extend when the seat is in use.

2. The child seat of claim 1 comprising a harness suitable to retain a child in the seat.

3. The child seat of claim 1 comprising at least one connection member suitable to attach the seat to a chair.

4. The child seat of claim 1 comprising a first connection member suitable to connect the child seat to a seat of a chair and a second connection member suitable to connect the child seat to a back of a chair.

5. The child seat of claim 4 wherein the first connection member is formed in two parts with a first part extending from a first side of the base and a second part extending from a second side of the base.

6. The child seat of claim 4 wherein the second connection member is formed in two parts with a first part extending from a first side support and a second part extending from a second side support.

7. The child seat of claim 1 wherein the front support comprises first and second openings through which respective legs of a child may extend when the seat is in use.

8. The child seat of claim 1 comprising a pair of openings through which an aeroplane seatbelt may be positioned over a child's lap such that the seatbelt restrains a child sat on the child seat.

9. The child seat of claim 1 wherein each side support comprises an opening through which an aeroplane seatbelt may be positioned over a child's lap such that the seatbelt restrains a child sat on the child seat.

10. The child seat of claim 1 wherein the child seat comprises at least one non-return valve and at least one standard air valve.

11. The child seat of claim 1 wherein the base is in fluid connection with the side supports.

12. The child seat of claim 1 wherein the base is in fluid connection with the side and rear supports so as to allow simultaneous inflation and deflation thereof.

13. The child seat of claim 1 wherein the base is in fluid connection with the side, front and rear supports so as to allow simultaneous inflation and deflation thereof.

14. (canceled)
